(19) United States
(12) Patent Application Publication
(10) Pub. No.: US 2017/0208844 A1
(43) Pub. Date: Jul. 27, 2017

(54) METHOD FOR PROVIDING A MARBLEIZED MEAT PRODUCT

(71) Applicant: CARGILL, INCORPORATED, Wayzata, MN (US)

(72) Inventors: Matthew A. GARDNER, Wichita, KS (US); Phillip J. RINCKER, Wichita, KS (US)

(21) Appl. No.: 15/395,820

(22) Filed: Dec. 30, 2016

Related U.S. Application Data
(63) Continuation of application No. 13/002,165, filed on Dec. 30, 2010, now abandoned.
(60) Provisional application No. 61/133,984, filed on Jul. 3, 2008.

(51) Int. Cl. A23L 13/70

(52) U.S. Cl. CPC A23L 13/72; A23V 2002/00

(57) ABSTRACT

Marbleized meat products are prepared by providing a fat composition comprising fat and an emulsifier, the fat composition being at a temperature of from about 70° to about 120° C., wherein substantially all of the fat is from an animal source; and providing a water composition at a temperature of from about 15° to about 32° C. The fat composition and the water composition are mixed at a ratio of from about 5% to about 30% fat composition to form a homogeneous fat-containing liquid brine composition at a temperature of at least about 25° C., wherein a fat-containing liquid brine composition is substantially free of Allergenic Protein. The composition is cooled to a temperature at or less than about 10° C. and injected into a meat portion to provide a marbleized meat product. The average temperature of the marbleized meat product does not exceed about 7° C.

### CROSS-REFERENCE TO RELATED APPLICATIONS

This application claims the benefit of U.S. Provisional Application Ser. No. 61/133,984, filed Jul. 3, 2008, entitled “Method For Providing a Marbleized Meat Product” which application is incorporated herein by reference in its entirety.

### FIELD OF THE INVENTION

The present invention relates to enhanced meat products and methods. More specifically, the present invention relates to a method for enhancing meat products by injecting a homogenized fat-containing brine composition into a meat portion to provide a marbleized meat product, and meat products made by the method.

### BACKGROUND OF THE INVENTION

Meat is a highly desired food for many people. The nature of the cut of meat determines the relative value of the particular meat product. Specifically, meat that contains a relatively high amount of fat marbling is considered by many to be more valuable, because such meats exhibit the best flavor and tenderness. Low quality meats are meats that have a low content of fat marbling, and have a very small market in the U.S. due to issues with tenderness and flavor. The amount of low fat meat product that is produced in the U.S. is expected to rise with higher feed costs and the penetration of feed additives and other products that increase the feed efficiency and leanness of beef animals.

Many approaches have been used to enhance the value of meat cuts. For example, brine mixtures including gelatin, water and optional additives have been dispersed into meats in order to enhance the meat product, as is described in PCT applications WO07070686A1, WO07047525A2, and WO07109060A2 (U.S. patent application Ser. No. 12/224,971), the disclosures of which are incorporated by reference for all purposes).

One approach for providing a marbled meat product is to directly inject a meat portion with fat, as described in JP 59-23777. In this reference, a composition comprising a high percentage of fat is injected into the meat in the liquid state, and “precipitated” into the meat by cooling the meat to a temperature of 15-40° C. or 5-35° C. In a similar method as described in JP 59-162853, an emulsion containing a very high percentage of fat is formed using a protein in the composition. The resulting emulsion is injected at a temperature of 50-60° C. Under these approaches, the meat reaches an undesirably high temperature during processing.

A somewhat different technique is described in U.S. Pat. No. 4,960,599 to Cozzini et. al., where a cold particle suspension is injected into the meat portion. The suspension is created by removing trim from meat, freezing the trim and mixing it with very cold brine. The suspension is not a stable emulsion, and would be expected to separate at processing temperatures above 32° F.

Injection of an oil and fat emulsion is described in U.S. Pat. No. 4,988,524 to Obata et. al., wherein the fat is emulsified by use of a casein alkali salt, and is injected into the meat. The meat is then brought to a temperature of 13 to 15° C. to coagulate the emulsified product. See column 2, lines 35-47 and column 3, line 22.

U.S. Pat. No. 5,039,538 to Tamaki et. al. also describes injecting meat with a fat emulsion to provide a marbled meat. Tamaki et al. use a protein in their composition, and specifically identify allergen proteins at column 2, lines 52-59.

An approach to provide a fat composition suitable for injecting into meat at low temperature is described in US Patent Application Publication No. 2002/0155201, which uses an emulsion comprising oil and fat of animals and plants.

In an alternative approach, a composition comprising many ingredients is described in US Patent Application Publication No. US 2006/0068077. The disclosed composition contains a large mount of starch and saccharified starch, and is apparently injected into the meat at a high temperature.

There is a need to be able to upgrade low quality meat products by the use of enhancement technology.

### SUMMARY OF THE INVENTION

The present invention provides a meat product that has the appearance, cooking and flavor characteristics of a high value meat product, created by treating a lower value meat product with a fat composition as described herein. In addition to the improved appearance, the injection solution improves the tenderness and juiciness of the product. Thus, the injected fat composition not only changes the physical appearance of the meat product, but also protects the flavor of the meat product after injection. In an embodiment of the present invention, a low marbled beef is made to exhibit organoleptic properties of a USDA Choice beef.

The present invention provides a method of producing a marbleized meat product comprising:

a) providing a fat composition comprising fat and an emulsifier, the fat composition being at a temperature of from about 70° to about 120° C., wherein substantially all of the fat is from an animal source;

b) providing a water composition at a temperature of from about 15° to about 32° C.;

c) mixing the fat composition and the water composition at a ratio of from about 5% to about 30% fat composition to form a homogeneous fat-containing liquid brine composition at a temperature of at least about 25° C., wherein a fat-containing liquid brine composition is substantially free of Allergenic Protein;

d) cooling the fat-containing brine composition to a temperature at or less than about 10° C.;

e) injecting the cooled homogenized fat-containing brine composition into a meat portion to provide a marbleized meat product; and

f) storing the marbleized meat product at a temperature below about 7° C.;

wherein throughout the method, the average temperature of the marbleized meat product does not exceed about 7° C.

Meat products made by this method are also provided.

The meats comprising added fat as prepared by the present method have increased value as compared to lower fat content meats. Additionally, the present invention advantageously permits production of meat products having a specifically predetermined fat content, because the total fat content of the final product can be controlled by the producer. Thus, meat products may now be prepared having a fat content that is tailored to meet dietary and consumer desires.

The method of the present invention can be carried out under excellent food safety standards by assuring production in a controllably clean environment with temperature control of all components. Advantageously, the method can be carried out during the production process so that the meat portion never is exposed to a high temperature that compromises the safety of the food product. In a preferred embodiment of the present invention, once the fat-containing brine composition is prepared and cooled, both the brine and the meat portion to be treated are maintained at a temperature of from about 0° C. to about 2° C. throughout the injection and storage steps.

Because the homogenized fat-containing brine composition as used in the present method is prepared under the unique conditions and material selection as set forth herein, the injection process can be carried out at a desirably low temperature and using standard injection equipment. The fat-containing brine composition is prepared so that the composition is pumpable at the desired temperature of injection. Preferably, the fat-containing brine composition has a viscosity of less than about 250 cP at 10° C. as measured herein.

Furthermore, the present invention permits flexibility in selection of additional additives to the homogenized fat-containing brine composition so that the ultimate product can exhibit an enhanced flavor and/or protected flavor over the projected storage lifetime of the product.

The present method also advantageously makes it possible to deliver meat products on a mass production basis that exhibit uniform organoleptic properties. Product consistency from an appearance, texture, and flavor standpoint can be assured, enhancing value to the consumer because the product quality can be dependably delivered.

The product of the present invention advantageously may be stored and cooked from the refrigerated state or the frozen state.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

The meat to be treated in accordance with the present invention may be any variety of meat from any species. Suitable meats include those obtained from bovine, porcine, equine, caprine, ovine, avian animals, or any animal commonly slaughtered for food production. Bovine animals may include, but are not limited to, buffalo, and all cattle, including steers, heifers, cows, and bulls. Porcine animals may include, but are not limited to, feeder pigs and breeding pigs, including sows, gilts, barrows, and boars. Ovine animals may include, but are not limited to, sheep, including ewes, rams, wethers, and lambs. Poultry may include, but are not limited to, chicken, turkey, and ostrich.

In a preferred embodiment, the meat to be treated is beef or pork. Although the following description is directed towards fresh beef cuts, embodiments of the present invention may be suitable for other types of meat.

The meat may be provided in any suitable cut or portion, including whole carcasses (especially poultry), primals (hams), sub-primals, steaks, and irregular cuts. In a preferred embodiment, the meat is provided in cut portions wherein the marbling can be observed by the potential purchaser prior to purchase. In a particularly preferred embodiment, the meat is provided in a cut steak portion.

As noted above, a fat composition is used in the present process that comprises fat and an emulsifier.

The fat is any suitable fat, wherein substantially all of the fat is from an animal source. Limiting the fat to animal sources is particularly beneficial in order to preserve flavor and ingredient consistency in the meat product. Preferably, the fat is a fat sourced from the same animal species as the meat to be treated. This embodiment is particularly preferred because flavor and ingredient consistency is particularly maximized. In an embodiment, the fat is tallow from a bovine source (preferably cattle). In another embodiment, the fat is tallow from an ovine source (preferably sheep). In another embodiment, the fat is lard from a porcine source. In an embodiment, the fat is obtained from the rendering of beef co-products. The co-products are heated and the liquid fat is removed. The tallow preferably is substantially free of protein and water. Further processing of tallow includes steps such as caustic refining (removes free triglycerides to improve flavor and stability), bleaching (removes unwanted color), and deodorizing (removes unwanted odors).

Emulsifier is used in preparing the fat composition, in order to provide stability and other desired handling properties. The emulsifier may be selected from any suitable emulsifier for use in food products. Examples of emulsifiers include lecithin (such as soy lecithin and sunflower lecithin), distilled monoglycerides, and emulsifiers derived from tallow (i.e. a self-emulsifying tallow generated by chemically processing the tallow with NaMeOH as a catalyst).

The emulsifier is mixed with the fat in an amount effective to emulsify the fat with the water to be provided in step b) of the method. For example, the amount of lecithin to be incorporated is generally calculated based on the amount of fat or oil in the emulsion. Typical amounts are in the range of 10-15% by weight of the weight of the fat when using liquid lecithin.

The fat composition is brought to a temperature of from about 70° to about 120° C., before, during or after mixing of the fat with the emulsifier.

A water composition is additionally provided, and brought to a temperature of from about 15° to about 32° C.

Either the fat composition or the water composition may additionally comprise optional ingredients, such as flavorants, etc., as discussed more completely below.

The fat composition and the water composition are mixed at a ratio of from about 5% to about 30% fat composition, and more preferably from about 10% to about 20% fat to form a fat-containing liquid brine composition. The respective temperatures of the fat composition and the water composition and conditions of mixing are selected so that the resulting fat-containing liquid brine composition is mixed at a temperature of at least about 25° C.

The fat-containing liquid brine composition is substantially free of Allergenic Protein. For purposes of the present invention, an Allergenic Protein is a protein from a food source selected from the group consisting of peanuts, soybeans, cow's milk, eggs, fish, crustacean shellfish, tree nuts, and wheat. These food sources are recognized as the source of 90 percent of food allergies in the US, and so the presence of proteins from these sources in the meat of the present invention is undesirable. Additionally, the Food Allergen Labeling and Consumer Protection Act of 2004 requires that the label of a food that contains an ingredient that contains protein from one of these food sources declare the presence of the allergen in the food.

In an embodiment of the present invention, the fat-containing brine composition is substantially free of proteins from a source other than the type of meat that is to be marbleized. In another embodiment of the present invention, the marbleized meat product is substantially free of non-endogenous enzymes. This embodiment is advantageous in that the meat product does not contain enzymes that do not naturally occur in the meat product, which some consumers may find to be objectionable or undesirable.

In an embodiment of the present invention, no single ingredient other than fat, antimicrobials and water is present in the fat-containing brine composition in an amount greater than about 10% by weight. This embodiment is advantageous in that the amount of each individual additive to the meat product is comparatively low. This is beneficial because no individual additive is present in an amount that will dominate any aspect of the organoleptic properties of the final product such as flavor and/or texture of the meat pro product. In another embodiment of the present invention, the total amount of ingredients other than fat, antimicrobials and water in the fat-containing brine composition does not exceed about 25% by weight of the composition. This embodiment likewise may be beneficial in flavor and texture properties of the meat, and/or from the perspective of providing a more “natural” food product without an undesired content of fillers or additives that certain consumers may find to be objectionable or undesirable. In another embodiment of the present invention, no single ingredient other than fat, antimicrobials and water is present in the fat-containing brine composition in an amount greater than about 10% by weight; and the total amount of ingredients other than fat, antimicrobials and water in the fat-containing brine composition does not exceed about 25% by weight of the composition.

The fat composition and the water composition may be mixed using any appropriate mixing system. In an embodiment of the present invention, the fat composition and the water composition may be mixed in a two step process comprising first mixing the fat composition and the water composition and then further aggressively mixing the fat-containing brine composition to homogenize the fat-containing brine composition. The first mixing step may be carried out using a mixer appropriate for initial mixing, such as a hand held high speed mixer or its large scale equivalent. The mixing may be carried out in a batch process or a continuous mixing process. In the two step mixing process embodiment, the fat-containing brine composition is then further mixed to homogenize the fat-containing brine composition. This homogenization step may be carried out using any suitable homogenizer high shear mixer, or the like. An example of a homogenizer is the Gaulin model 31 M homogenizer or its large scale equivalent.

In another embodiment of the present invention, the homogenization step is carried out by exposing the fat-containing brine composition to ultrasonic energy. The use of ultrasonic energy may reduce foam formation or otherwise control the presence of foam, and also may provide reduction of microbial content of brine or reduction in the viscosity of the homogenized fat-containing brine composition.

As used herein, “ultrasonic energy” means mechanical, vibratory energy that operates at frequencies greater than audible sound. “Ultrasonic energy” has a frequency that is inaudible to the human ear, typically at least about 10 kHz, and more typically at least about 16 kHz or at least about 20 kHz. Systems for generating ultrasonic energy are available from commercial sources (e.g., Hielscher GmbH, Teltow, Del.). The ultrasonic energy generated by these systems typically has a frequency of about 15-100 kHz. In some embodiments, the ultrasonic energy has a frequency of about 20-50 kHz. In some embodiments, the ultrasonic energy has a frequency of about 16-50 kHz or more preferably about 16-24 kHz. In some embodiments, the meat and/or homogenized fat-containing brine composition is subjected to ultrasonic energy having a power of about 0.2-25 kW. In other embodiments, the meat and/or homogenized fat-containing brine composition is subjected to ultrasonic energy having a power of about 0.3-20 kW. In further embodiments, the meat and/or homogenized fat-containing brine composition is subject to ultrasonic energy having a power of about 0.4-15 kW.

The homogenization step may be carried out in a batch process or a continuous homogenization process.

Alternatively, fat composition and the water composition may be mixed in a one step process, using equipment capable of providing a homogenized fat-containing brine composition, such as described above.

The homogenized fat-containing brine composition is then cooled to a temperature at or less than about 10° C., and preferably to a temperature at or less than about 4.5° C. The fat-containing brine composition is prepared so that the composition is pumpable at the desired temperature of injection. Preferably, the fat-containing brine composition has a viscosity of less than about 250 cP at 10° C., preferably at a temperature of 4.5° C., and more preferably at a temperature of 0° C.

In an embodiment of the present invention, the composition components and conditions of homogenization are selected to provide a homogenized fat-containing brine composition that has a viscosity of from about 10 to about 250 cP, more preferably from about 20 to about 150 cP at 10° C. In another embodiment of the present invention, the composition components and conditions of homogenization are selected to provide a homogenized fat-containing brine composition that has a viscosity of from about 10 to about 250 cP, more preferably from about 20 to about 150 cP at 4.5° C. In another embodiment of the present invention, the composition components and conditions of homogenization are selected to provide a homogenized fat-containing brine composition that has a viscosity of from about 10 to about 250 cP, more preferably from about 20 to about 150 cP at 0° C.

For purposes of the present invention, viscosity measurements are carried out using a Brookfield viscometer with a #62 probe at 50 rpm at the indicted temperature.

The homogenized fat-containing brine composition is injected into a meat portion to provide a marbleized meat product. In an embodiment of the present invention, an amount of homogenized fat-containing brine composition is injected into the meat portion to provide from about 1 to about 5%, more preferably from about 1.5 to about 3%, added fat in the final product.

Preferably, the homogenized fat-containing brine composition is injected into the meat portion within about 8 hours of the homogenized fat-containing brine composition being cooled to a temperature at or less than about 10° C., and preferably at a temperature at or less than about 4.5° C. The homogenized fat-containing brine composition is preferably at this reduced temperature when it is injected into the meat portion.

The homogenized fat-containing brine composition is injected into a meat portion using any suitable injection equipment, including but not limited to equipment manufactured by Wolf-Tech, Kingston, N.Y. This equipment generally draws liquid brine from a tank and delivers it using pressure through needles to the meat portions. An example of a commercially available brine injector/pump is the Schröder IMAX 630 available from Wolf-Tech, Kingston, N.Y. Another example of an injector system is the Stork/Townsend 1400 injector.

The homogenized fat-containing brine composition preferably meets the above noted viscosity properties for most effective processing operations.

Preferably, the homogenized fat-containing brine composition components and injection conditions are selected to minimize generation of foam during the injection process. Various approaches to minimize foam may be used individually or in combination. For example, injection under low pressure has been found to be desirable. Additionally, injection using a simplified hypodermic type needle system with the only hole at the tip of the needle is also desirable under certain conditions. While not being bound by theory, it is believed that this injection configuration may be less abusive on the brine and result in less foaming.

After injection of the homogenized fat-containing brine composition into the meat portion, the marbleized meat product is stored at a temperature below about 7° C.

Significantly, throughout the method of the present invention, the average temperature of the marbleized meat product does not exceed about 7° C. The ability to provide this marbleized meat product using a process that meets or exceeds established food safety standards is a significant advance in the art.

As noted above, the homogenized fat-containing brine composition used in the present invention may also include a variety of optional additives. Examples of suitable additives may include salts, synthetic antioxidants, natural antioxidants such as rosemary, and antimicrobials (e.g. bacterial and other pathogen inhibitors such as sodium or potassium lactate). Additionally, flavorings such as beef, pork or similar materials as appropriate to the particular meat product may be included to supplement water in the brine. Flavorants are commercially available from many sources, such as Givaudan SA, Vernier, Switzerland.

In some embodiments, the homogenized fat-containing brine composition may be salt-free, (i.e., the homogenized fat-containing brine composition has a salt content at or less than about 1 ppm). In further embodiments, the homogenized fat-containing brine composition may comprise phosphate, for example in the form of sodium phosphate (commercially available as Brifisol® 85 Instant (BK Giulini Corporation, Simi. Valley, Calif.)). In further embodiments, the homogenized fat-containing brine composition may be phosphate-free (i.e., the brine product has a phosphate content at or less than about 1 ppm).

In an embodiment of the present invention, the homogenized fat-containing brine composition used in the present invention may have a pH close to the approximate pH of un-enhanced fresh meat. The resulting fresh meat cuts enhanced with these homogenized fat-containing brine compositions may therefore have a pH, between about 5 and 7, that is similar to un-enhanced fresh meat cuts.

The homogenized fat-containing brine composition may optionally comprise an antifoaming agent, such as Dow Corning Antifoam FG-10.

In an embodiment of the present invention, the homogenized fat-containing brine composition used in the present invention comprises starch for superior moisture retention properties in the ultimate meat product. Moisture retention is particularly advantageous in meat products that are held at a serving temperature for a time (such as 5-20 minutes) after cooking and prior to consumption. In an embodiment of the present invention, the fat-containing brine composition contains starch in an amount up to about 10% by weight.

In addition to the foregoing, the marbleized meat may be tumbled, kneaded, massaged or otherwise manipulated after injection of the homogenized fat-containing brine composition into the meat portion. Additional meat processing procedures, such as using carbon monoxide (CO) as a process aid to ameliorate the loss of the red color of beef, may be incorporated as appropriate.

In a preferred embodiment, the fat-containing brine composition consists essentially of, or alternatively consists of

| | |
|---|---|
| Tallow | 5-30% |
| sodium phosphate | 0.5-5% |
| Salt | 0.5-5% |
| Lecithin | 0.3-5% |
| Flavor | 0-8% |
| water | Qs |

In an alternative preferred embodiment, the fat-containing brine composition consists essentially of, or alternatively consists of

| | |
|---|---|
| Tallow | 5-30% |
| sodium phosphate | 0.5-5% |
| Salt | 0.5-5% |
| Lecithin | 0.2-5% |
| Starch | 0.5-8% |
| Dextrose | 0.3-3% |
| Flavor | 0-8% |
| water | qs |

Preferably, the lecithin is sunflower lecithin.

### EXAMPLES

Representative embodiments of the present invention will now be described with reference to the following examples that illustrate the principles and practice of the present invention.

### Brine Formulation:

The following formulations were prepared and injected into beef meat portions.

| | FINISHED PRODUCT | BRINE |
|---|---|---|
| Example 1 | COMPOSITION | COMPOSITION % |
| WATER | | 73.325 |
| Tallow | 2.000% | 22.000 |
| Sodium Phosphate¹ | 0.200% | 2.200 |
| Salt | 0.200% | 2.200 |
| Soy lecithin | 0.025% | 0.275 |

| | FINISHED PRODUCT | BRINE |
|---|---|---|
| Example 2 | COMPOSITION | COMPOSITION % |
| WATER | | 73.050 |
| Tallow | 2.000% | 22.000 |
| Sodium Phosphate¹ | 0.200% | 2.200 |
| Salt | 0.200% | 2.200 |
| Soy lecithin | 0.050% | 0.550 |

| | FINISHED PRODUCT | BRINE |
|---|---|---|
| Example 3 | COMPOSITION | COMPOSITION % |
| WATER | | 72.775 |
| Tallow | 2.000% | 22.000 |
| Sodium Phosphate¹ | 0.200% | 2.200 |
| Salt | 0.200% | 2.200 |
| Soy lecithin | 0.075% | 0.825 |

| | FINISHED PRODUCT | BRINE |
|---|---|---|
| Example 4 | COMPOSITION | COMPOSITION % |
| WATER | | 72.500 |
| Tallow | 2.000% | 22.000 |
| Sodium Phosphate¹ | 0.200% | 2.200 |
| Salt | 0.200% | 2.200 |
| Soy lecithin | 0.100% | 1.100 |

| | FINISHED PRODUCT | BRINE |
|---|---|---|
| Example 5 | COMPOSITION | COMPOSITION % |
| WATER | | 71.950 |
| Tallow | 2.000% | 22.000 |
| Sodium Phosphate¹ | 0.200% | 2.200 |
| Salt | 0.200% | 2.200 |
| Soy lecithin | 0.150% | 1.650 |

| | FINISHED PRODUCT | BRINE |
|---|---|---|
| Example 6 | COMPOSITION | COMPOSITION % |
| WATER | | 71.400 |
| Tallow | 2.000% | 22.000 |
| Sodium Phosphate¹ | 0.200% | 2.200 |
| Salt | 0.200% | 2.200 |
| Soy lecithin | 0.200% | 2.200 |

¹Brifisol ® 85 Instant

Additional formulations are prepared as follows:

Example 7

| | |
|---|---|
| WATER | 85.084% |
| Tallow | 10.010% |
| Sodium Phosphate | 2.200% |
| Salt | 2.200% |
| Sunflower Lecithin | 0.506% |

Example 8

| | |
|---|---|
| WATER | 79.892% |
| Tallow | 14.960% |
| Sodium Phosphate | 2.200% |
| Salt | 2.200% |
| Sunflower Lecithin | 0.748% |

Example 9

| | |
|---|---|
| WATER | 76.036% |
| Tallow | 9.960% |
| Sodium Phosphate | 2.100% |
| Salt | 3.000% |
| Sunflower Lecithin | 0.504% |
| Starch | 3.600% |
| Dextrose | 0.600% |
| Beef Flavor | 4.200% |

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A method of producing a marbleized meat product comprising:
a) providing a fat composition comprising fat and an emulsifier, the fat composition being at a temperature of from about 70° to about 120° C., wherein substantially all of the fat is from an animal source;
b) providing a water composition at a temperature of from about 15° to about 32° C.;
c) mixing the fat composition and the water composition at a ratio of from about 5% to about 30% fat composition to form a homogeneous fat-containing liquid brine composition at a temperature of at least about 25° C., wherein a fat-containing liquid brine composition is substantially free of Allergenic Protein;
d) cooling the fat-containing brine composition to a temperature at or less than about 10° C.;
e) injecting the cooled homogenized fat-containing brine composition into a meat portion to provide a marbleized meat product; and
f) storing the marbleized meat product at a temperature below about 7° C.; wherein throughout the method, the average temperature of the marbleized meat product does not exceed about 7° C.

2. The method of claim 1, wherein the homogenized fat-containing brine composition is at a temperature of less than about 4.5° C. when it is injected into the meat portion.

3. The method of claim 1, wherein the homogenized fat-containing brine composition has a viscosity of from about 10 to about 250 cP at 10° C.

4. The method of claim 1, wherein the homogenized fat-containing brine composition has a viscosity of from about 20 to about 150 cP at 10° C.

5. The method of claim 1, wherein the homogenized fat-containing brine composition has a viscosity of from about 10 to about 250 cP at 4.5° C.

6. The method of claim 1, wherein the homogenized fat-containing brine composition has a viscosity of from about 20 to about 150 cP at 4.5° C.

7. The method of claim 1, wherein the fat-containing brine composition is homogenized by exposure of the fat-containing brine composition to ultrasonic energy.

8. The method of claim 1, wherein the homogenized fat-containing brine composition is injected into the meat portion to provide from about 1 to about 5% percent additional fat in the marbleized meat product.

9. The method of claim 1, wherein the homogenized fat-containing brine composition is injected into the meat portion to provide from about 1.5 to about 3 percent additional fat in the marbleized meat product.

10. The method of claim 1, wherein the marbleized meat product is substantially free of non-endogenous enzyme.

11. The method of claim 1, wherein the homogenized fat-containing brine composition comprises one or more additives selected from the group consisting of salt, synthetic antioxidants, natural antioxidants, and bacterial and pathogen inhibitors.

12. The method of claim 1, wherein the homogenized fat-containing brine composition is phosphate-free.

13. The method of claim 1, wherein the homogenized fat-containing brine composition comprises an antifoaming agent.

14. The method of claim 1, wherein the marbleized meat product is beef.

15. The method of claim 14, wherein the fat is beef tallow.

16. The method of claim 1, wherein the marbleized meat product is pork.

17. The method of claim 16, wherein the fat is pork lard.

18. The method of claim 1, wherein no single ingredient other than fat, antimicrobials and water is present in the fat-containing brine composition in an amount greater than about 10% by weight.

19. The method of claim 1, wherein the total amount of ingredients other than fat, antimicrobials and water in the fat-containing brine composition does not exceed about 25% by weight of the composition.

20. The method of claim 1, wherein no single ingredient other than fat, antimicrobials and water is present in the fat-containing brine composition in an amount greater than about 10% by weight; and the total amount of ingredients other than fat, antimicrobials and water in the fat-containing brine composition does not exceed about 25% by weight of the composition.

21. The method of claim 1, wherein the fat-containing brine composition contains starch in an amount up to about 10% by weight.

22. The method of claim 1, wherein the fat-containing brine composition consists essentially of

| | |
|---|---|
| Tallow | 5-30% |
| sodium phosphate | 0.5-5% |
| Salt | 0.5-5% |
| Lecithin | 0.3-5% |
| Flavor | 0-8% |
| water | qs. |

23. The method of claim 20, wherein the lecithin is sunflower lecithin.

24. The method of claim 1, wherein the fat-containing brine composition consists essentially of

| | |
|---|---|
| Tallow | 5-30% |
| sodium phosphate | 0.5-5% |
| salt | 0.5-5% |
| lecithin | 0.2-5% |
| Starch | 0.5-8% |
| Dextrose | 0.3-3% |
| Flavor | 0-8% |
| water | Qs. |

25. The method of claim 1, wherein the homogenized fat-containing brine composition in step c) is prepared in a two step process comprising first mixing the fat composition and the water composition and then further aggressively mixing the fat-containing brine composition to homogenize the fat-containing brine composition.
